(19) United States
(12) Patent Application Publication
(10) Pub. No.: US 2018/0307002 A1
(43) Pub. Date: Oct. 25, 2018

(54) PROJECTION OPTICAL SYSTEM AND PROJECTOR

(71) Applicant: SEIKO EPSON CORPORATION, Tokyo (JP)

(72) Inventors: Naoto TAKEHANA, Matsumoto-Shi (JP); Takuya HATANO, Suwa-Shi (JP)

(73) Assignee: SEIKO EPSON CORPORATION, Tokyo (JP)

(21) Appl. No.: 15/767,611

(22) PCT Filed: Oct. 20, 2016
(86) PCT No.: PCT/JP2016/081180

§ 371 Date: Apr. 11, 2018

(30) Foreign Application Priority Data
Oct. 28, 2015 (JP) 2015-211605

(51) Int. Cl. G02B 7/10; G02B 7/08; G03B 21/28; H04N 5/74

(52) U.S. Cl. CPC G02B 7/10; H04N 5/74; G03B 21/28; G02B 7/08

(57) ABSTRACT

A projection optical system capable of, for example, in application to a projector that performs short-throw projection, facilitating position adjustment of lenses (in particular, focus position adjustment in a manufacturing process) and a projector in which the projection optical system is used. A rotation restricting section is provided that is capable of restricting rotation ranges of a cam in focus position adjustment (position adjustment among lenses) during a manufacturing process according to rotating motions of the cam in a lens-barrel guide cylinder and a position-adjustment cam cylinder.

### TECHNICAL FIELD

The present invention relates to a projection optical system suitable for incorporation in a projector that enlarges and projects an image of an image display element and the projector.

### BACKGROUND ART

As a projection optical system suitable for a projector and incorporation in the projector, there is known, for example, a projection optical system that effectively prevents eclipse of a focused light beam by a lens barrel while reducing a tilt with respect to an optical axis of an oblique light beam in oblique projection using, for example, a fixed lens section, a movable lens section, and a concave mirror in order to perform projection from a short distance at a wide angle of view (short-distance projection) (see, for example, PTL 1).

In general, in a projection optical system applied to a projector that performs short-distance projection, there is a limitation on movement of a lens because of a mechanical restriction. On the other hand, a manufacturing error easily occurs because, for example, an aspherical lens and the like are used. For example, there is a problem in that, although position adjustment of a lens for focusing is essential in a manufacturing process, the adjustment is not always easily and accurately performed.

### CITATION LIST

### Patent Literature

PTL 1: JP-A-2011-85922

### SUMMARY OF INVENTION

The present invention has been devised in view of the background described above, and an object of the present invention is to provide a projection optical system capable of, for example, in application to a projector that performs short-distance projection, facilitating position adjustment of lenses (in particular, focus position adjustment in a manufacturing process) and a projector in which the projection optical system is used.

In order to achieve the object, a projection optical system according to the present invention includes: a lens-barrel guide cylinder that houses a lens group; a position-adjustment cam cylinder for position adjustment of the lens group housed in the lens-barrel guide cylinder; and a rotation restricting section capable of restricting rotation ranges of a cam in the lens-barrel guide cylinder and the position-adjustment cam cylinder.

In the projection optical system, in performing position adjustment among lenses such as focus position adjustment according to rotating motions of the cam in the lens-barrel guide cylinder and the position-adjustment cam cylinder, the rotation restricting section capable of restricting the rotation range of the cam is provided. Consequently, in application to a projector that performs short-distance projection, inparticular, it is possible to facilitate position adjustment of lenses such as focus position adjustment in a manufacturing process.

According to a specific aspect of the present invention, the projection optical system further includes a rotation fixing section capable of fixing a relative positional relation by the cam between the lens-barrel guide cylinder and the position-adjustment cam cylinder. In this case, for example, it is possible to fix and maintain disposition of the lens in a predetermined state.

According to another aspect of the present invention, the rotation restricting section and the rotation fixing section are capable of respectively performing rotation restriction and rotation fixing by using a jig. In this case, for example, it is possible to perform desired adjustment through the use of the jig in the manufacturing process.

According to still another aspect of the present invention, the rotation restricting section and the rotation fixing section are disposed side by side and respectively capable of performing rotation restriction and rotation fixing by exchanging a same jig. In this case, during the rotation restriction and during the rotation fixing, one jig can be exchanged and used in common, that is, used for both of the rotation restriction and the rotation fixing. Further, since the rotation restricting section and the rotation fixing section are disposed side by side, it is possible to quickly and accurately perform the exchange of the jig.

According to still another aspect of the present invention, the rotation restricting section includes: a first restricting section that forms a concave section or a hole section provided in the lens-barrel guide cylinder; and a second restricting section that forms a hole section or a cutout section provided in the position-adjustment cam cylinder. One of the first restricting section and the second restricting section extends along a circumferential direction of the lens-barrel guide cylinder. In this case, by restricting a range extending along the circumferential direction concerning either one of the first restricting section and the second restricting section, a restriction range (from another perspective, a range in which rotation is allowed) in the rotation restricting section can be defined.

According to still another aspect of the present invention, the position-adjustment cam cylinder adjusts a focus position under restriction by the rotation restricting section. In this case, for example, it is possible to easily and surely check position adjustment for focusing in the manufacturing process that is particularly easily become a problem in an optical system of short-distance projection.

According to still another aspect of the present invention, the rotation restricting section restricts a rotation range for adjustment of a focus position within a range equal to or smaller than a margin of a rotation range of the lens group for enabling focus adjustment in a screen size in a predetermined range. In this case, by restricting the rotation range in the rotation restricting section, it is possible to perform position adjustment for focusing while maintaining a desired screen size change.

According to still another aspect of the present invention, the projection optical system further includes a lens-posture adjusting mechanism that adjusts a posture of at least one lens among a plurality of lenses configuring the lens group. In this case, it is possible to perform posture adjustment of the constituent lenses with the lens-posture adjusting mechanism.

According to still another aspect of the present invention, the projection optical system further includes: a curved surface mirror disposed at an optical path post stage of the lens group; and a mirror-posture adjusting mechanism that adjusts a posture of the curved surface mirror. In this case, it is possible to perform posture adjustment of the curved surface mirror with the mirror-posture adjusting mechanism.

In order to achieve the object, a projector according to the present invention includes: a light modulating element that modulates light emitted from a light source and forms image light; and the profection optical system in any one of the aspects described above that projects the image light emitted from the light modulating element. In this case, since the projector includes the projection optical system in any one of the aspects, in performing short-distance projection, in particular, it is possible to facilitate position adjustment of lenses such as focus position adjustment in a manufacturing process.

### BRIEF DESCRIPTION OF DRAWINGS

FIG. 1 is a diagram showing a schematic configuration of a projector incorporating a projection optical system in an embodiment.

FIG. 2 is a perspective view showing an example of the projection optical system.

FIG. 3 is a perspective view at another angle showing an example of the projection optical system.

FIG. 4 is a perspective view showing the projection optical system in a disassembled state.

FIG. 5 is a perspective view showing a lens barrel section that houses lenses in FIG. 4.

FIG. 6 is a sectional view showing an example of the projection optical system.

FIG. 7 is a configuration from an object surface to a projection surface in the projection optical system and an example of a ray diagram.

FIG. 8 is a partially enlarged view from the object surface to a concave reflection mirror in FIG. 7.

FIGS. 9(A) to 9(C) are conceptual diagrams for explaining a rotation restricting section in a modification and FIGS. 9(D) to 9(F) are conceptual diagrams for explaining a rotation restricting section in another modification.

### DESCRIPTION OF EMBODIMENTS

A projection optical system according to an embodiment of the present invention is explained in detail below with reference to the drawings.

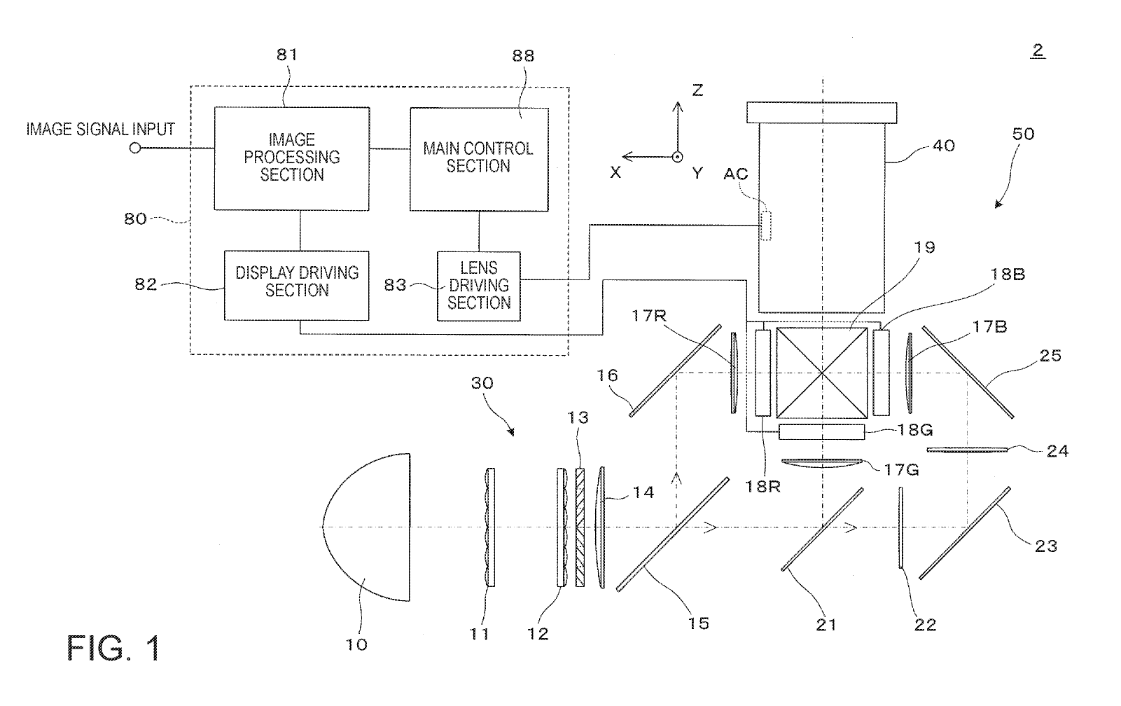

As shown in FIG. 1, a projector 2 incorporating the projection optical system according to the embodiment of the present invention includes an optical system portion 50 that projects image light and a circuit device 80 that controls the operation of the optical system portion 50.

In the optical system portion 50, a light source 10 is, for example, an ultrahigh pressure mercury lamp and emits light including R light, G light, and B light. The light source 10 may be an electric discharge light source other than the ultrahigh pressure mercury lamp or may be a solid-state light source such as an LED or a laser. A first integrator lens 11 and a second integrator lens 12 include pluralities of lens elements arrayed in an array shape. The first integrator lens 11 divides a light beam emitted from the light source 10 into a plurality of light beams. The lens elements of the first integrator lens 11 condense the light beam emitted from the light source 10 near the lens elements of the second integrator lens 12. The lens elements of the second integrator lens 12 form images of the lens elements of the first integrator lens 11 on liquid crystal panels 18R, 18G, and 18B in cooperation with a superimposition lens 14. With such a configuration, light emitted from the light source 10 illuminates entire display regions of the liquid crystal panels 18R, 18G, and 18B at substantially uniform brightness.

A polarization conversion element 13 converts light emitted from the second integrator lens 12 into predetermined linearly polarized light. The superimposition lens 14 superimposes the images of the lens elements of the first integrator lens 11 on the display regions of the liquid crystal panels 18R, 18G, and 18B via the second integrator lens 12.

A first dichroic mirror 15 reflects the R light made incident from the superimposition lens 14 and transmits the G light and the B light made incident from the superimposition lens 14. The R light reflected by the first dichroic mirror 15 passes through a reflection mirror 16 and a field lens 17R to be made incident on the liquid crystal panel 18R, which is a light modulating element. The liquid crystal panel 18R modulates the R light according to an image signal to thereby form an image of an R color.

A second dichroic mirror 21 reflects the G light emitted from the first dichroic mirror 15 and transmits the B light emitted from the first dichroic mirror 15. The G light reflected by the second dichroic mirror 21 passes through a field lens 17G to be made incident on the liquid crystal panel 18G, which is a light modulating element. The liquid crystal panel 18G modulates the G light according to an image signal to thereby form an image of a G color. The B light transmitted through the second dichroic mirror 21 passes through relay lenses 22 and 24, reflection mirrors 23 and 25, and a field lens 17B to be made incident on the liquid crystal panel 18B, which is a light modulating element. The liquid crystal panel 18B modulates the B light according to an image signal to thereby form an image of a B color.

Across dichroic prism 19 is a prism for light combination. The cross dichroic prism 19 combines the image of the R color, the image of the G color, and the image of the B color formed by the liquid crystal panels 18R, 18G, and 18B into image light and causes the image light to travel to a projection optical system 40.

The projection optical system 40 is a zoom lens for projection that enlarges and projects the image light formed by the cross dichroic prism 19 on a not-shown screen. As an example, it is assumed that the projection optical system 40 is designed to guarantee that the projection optical system 40 is capable of adjusting projection in a range of 60 to 100 inches on the basis of projection in a screen size of 74 inches from a default projection distance.

The circuit device 80 includes an image processing section 81 to which an external image signal such as a video signal is input, a display driving section 82 that drives, on the basis of an output of the image processing section 81, the liquid crystal panels 18G, 18R, and 18B provided in the optical system portion 50, a lens driving section 83 that operates a driving mechanism (not shown in the figure) provided in the projection optical system. 40 and adjusts a state of the projection optical system 40, and a main control section 88 that integrally controls the operations of the circuit portions 81, 82, and 83 and the like.

The image processing section 81 converts the input external image signal into an image signal including gradations of the colors. Note that the image processing section 81 can also perform various kinds of image processing such as distortion correction and color correction on the external image signal.

The display driving section 82 can operate the liquid crystal panels 18G, 18R, and 18B on the basis of the image signal output from the image processing section 81 and can cause the liquid crystal panels 18G, 18R, and 18B to form images corresponding to the image signal or images corresponding to images obtained by applying image processing to the images corresponding to the image signal.

The lens driving section 83 operates under the control by the main control section 88. The lens driving section 83 can perform focus adjustment at the time of a change of a projection distance in projection of an image onto the screen by the projection optical system 40 by appropriately moving a part of optical elements configuring the projection optical system 40 along an optical axis OA via an actuator AC (and a lever section LV driven by the actuator AC). Note that the lens driving section 83 can also change a vertical position of the image projected onto the screen according to adjustment of a tilt for moving the entire projection optical system 40 in an up-down direction perpendicular to the optical axis OA.

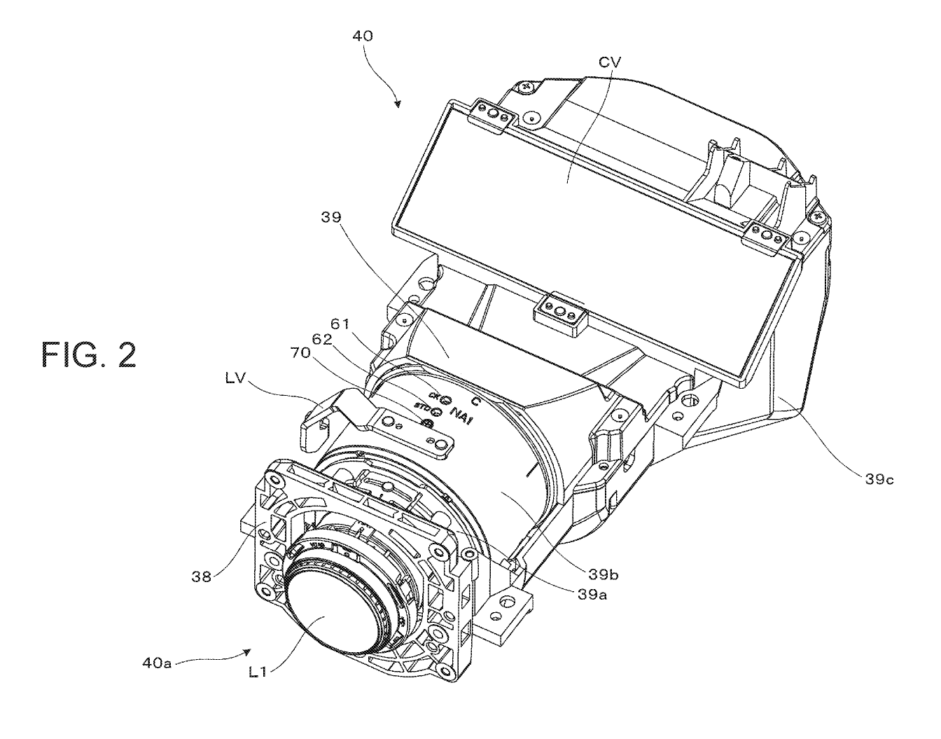

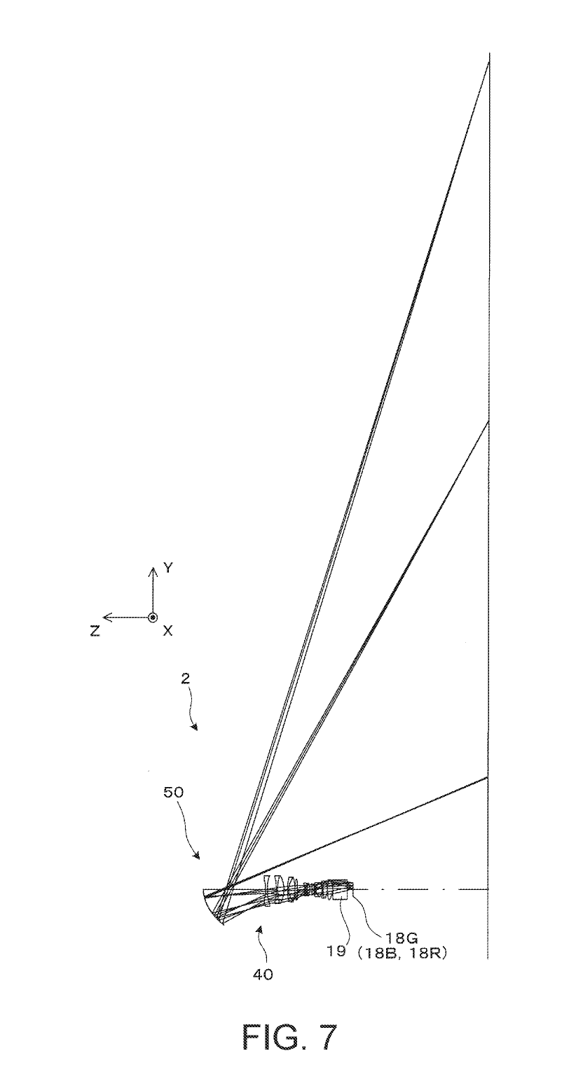

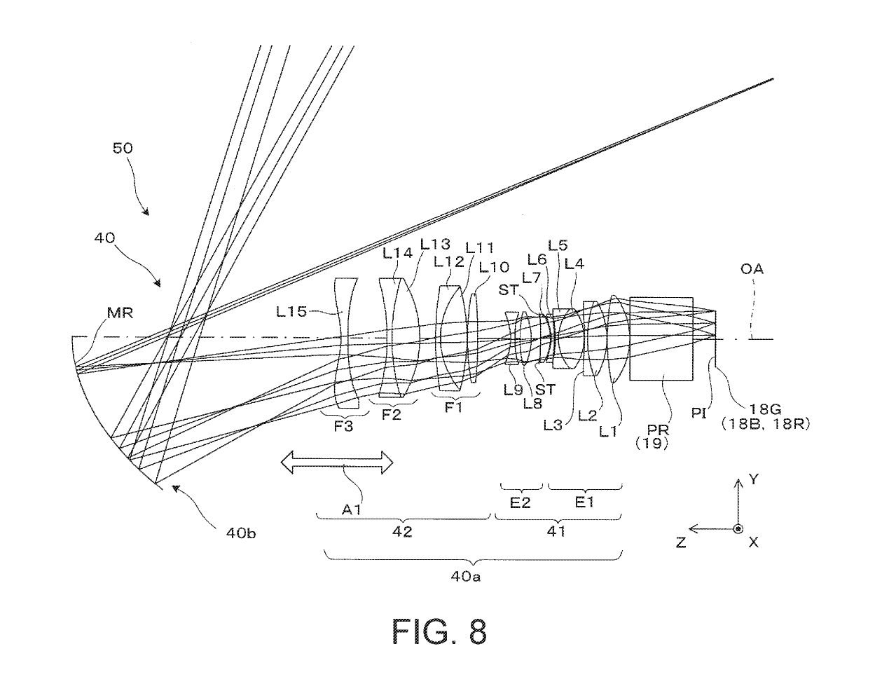

The structure of the projection optical system 40 in the embodiment is specifically explained below with reference to FIG. 2 and the like. Note that the projection optical system 40 illustrated in FIG. 2 and the like is configured to perform projection as indicated by an example explained below (see FIGS. 7 and 8).

As shown in FIG. 2 to FIG. 6, the projection optical system 40 includes, besides an optical system portion (a main portion having optical action) configured by pluralities of refractive lenses and mirror lenses, a lens barrel section 39 configured by a plurality of cylindrical frame structures for housing optical members such as lenses, an attachment section 38 for attachment to a main body portion of the projector 2 (see FIG. 1), a light transmissive cover member CV for protecting the lenses and mirrors, and a lever section LV for rotating a part of the lens barrel section 39 along the circumferential direction of a lens barrel. Note that in a manufacturing process, the lever section LV is not connected to the actuator AC (see FIG. 1) and is manually rotated by a person who performs position adjustment.

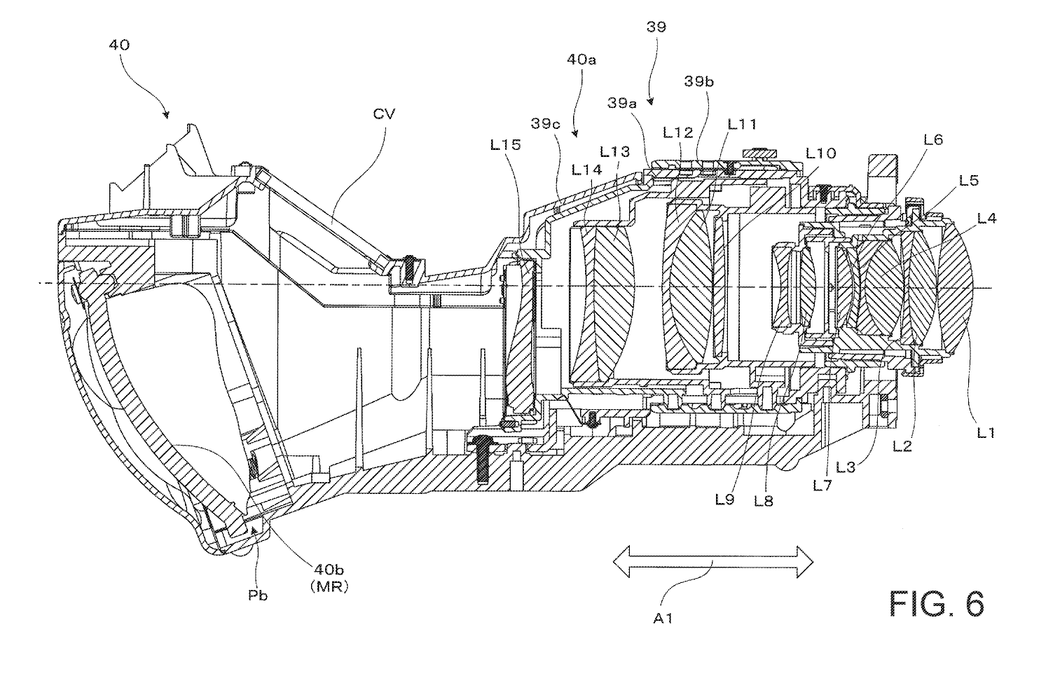

For example, as shown in FIG. 6, the optical system portion of the projection optical system 40 includes a first optical group 40a configured by fifteen lenses L1 to L15 and a second optical group 40b configured by a mirror MR (an aspherical mirror) including one reflection surface having a concave aspherical shape. With a configuration explained above, for example, as shown in FIG. 7 and FIG. 8, the projection optical system. 40 is capable of projecting an image formed in a display region of the liquid crystal panel 18G (18R, 18B) onto the not-shown screen at an ultra short focus.

Referring back to FIG. 6, the lens barrel section 39 is configured by a lens-barrel guide cylinder 39a that houses the fifteen lenses L1 to L15 configuring the first optical group (lens group) 40a, a position-adjustment cam cylinder 39b for position adjustment of the first optical group (lens group) 40a housed in the lens-barrel guide cylinder 39a, and a mirror cylinder 39c that houses the mirror MR configuring the second optical group 40b.

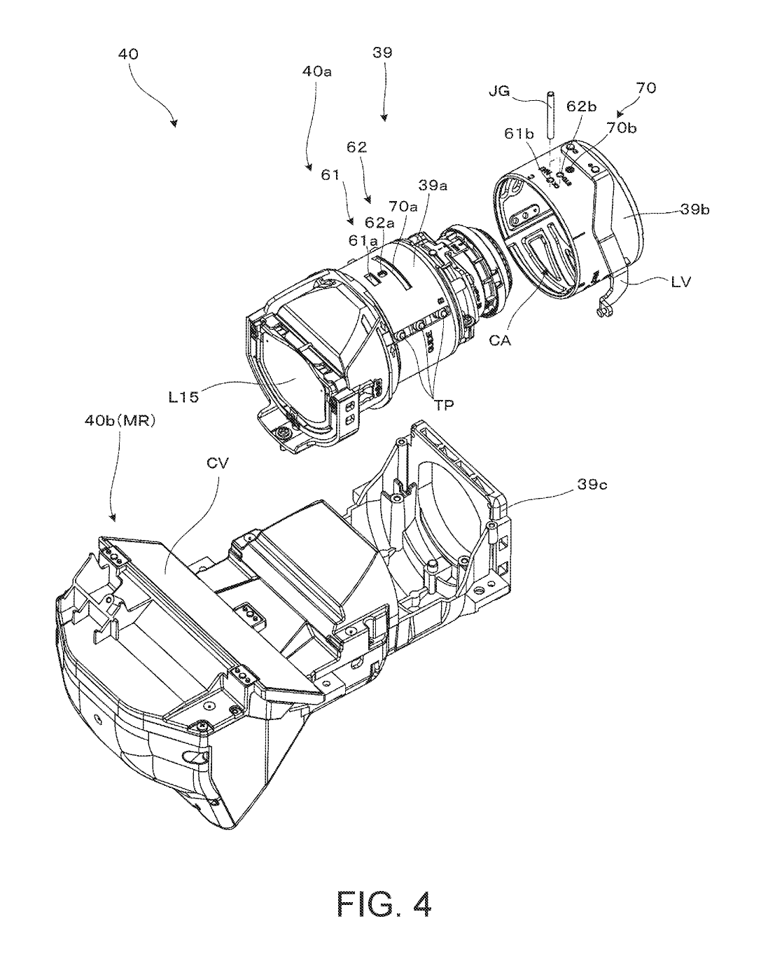

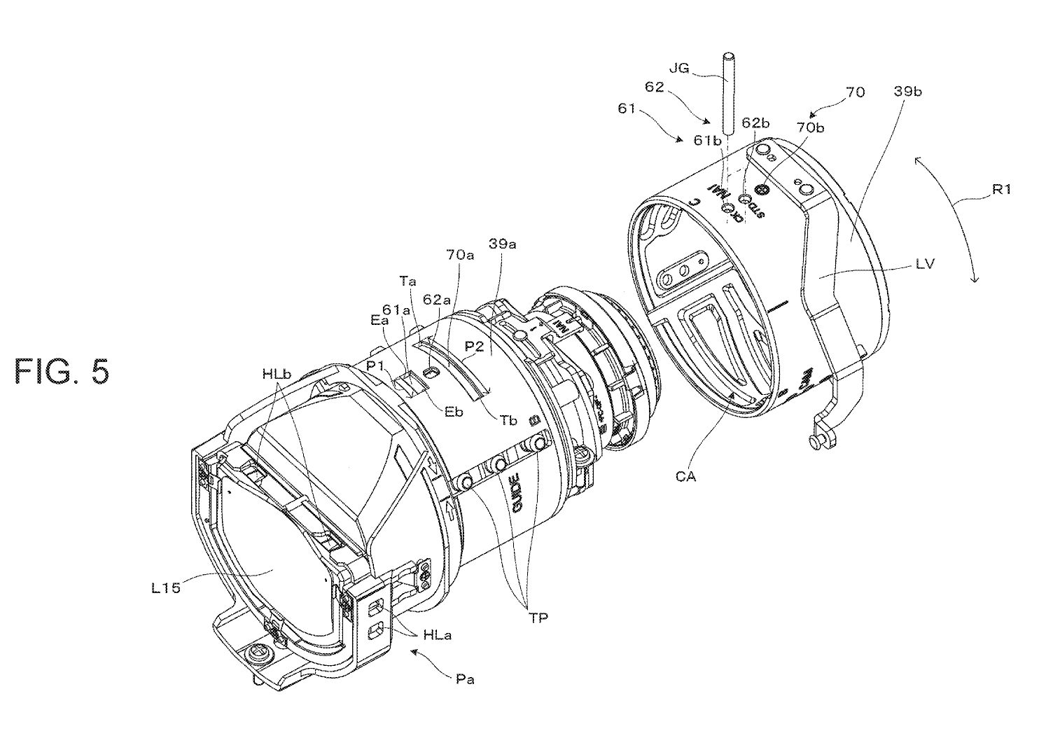

In the lens barrel section 39, for example, as shown in FIG. 4 to FIG. 6, the lens-barrel guide cylinder 39a is configured by a plurality of frame bodies and the like and screwed to the mirror cylinder 39c. Although detailed explanation of specific structure is omitted, the lens-barrel guide cylinder 39a is configured by combining a plurality of frame bodies such as a double frame structure to have a helicoidal structure or the like. In particular, as shown in FIG. 4 or FIG. 5, in the lens-barrel guide cylinder 39a, protrusion sections TP extending toward an outer surface from a plurality of frame bodies in which, for example, a singularity or a plurality of lenses are respectively unitized and housed on the inside. The protrusion sections TP are moved along an optical axis direction. Since the lens-barrel guide cylinder 39a has, for example, the double frame structure or the helicoidal structure, adjustment of a back focus, position adjustment among lenses for focusing, and the like of housed lenses (see the lenses L1 to L15 shown in FIG. 6) are possible. Besides, movement of an inter-lens distance (movement in a direction along the optical axis direction) in position adjustment for zooming after the projection optical system 40 is manufactured as a product is also possible. Note that, as structure other than this structure, as shown in FIG. 5, the lens-barrel guide cylinder 39a includes a lens-posture adjusting mechanism Pa for adjusting a posture of the lens L15 closest to the mirror MR (the second optical group 40b).

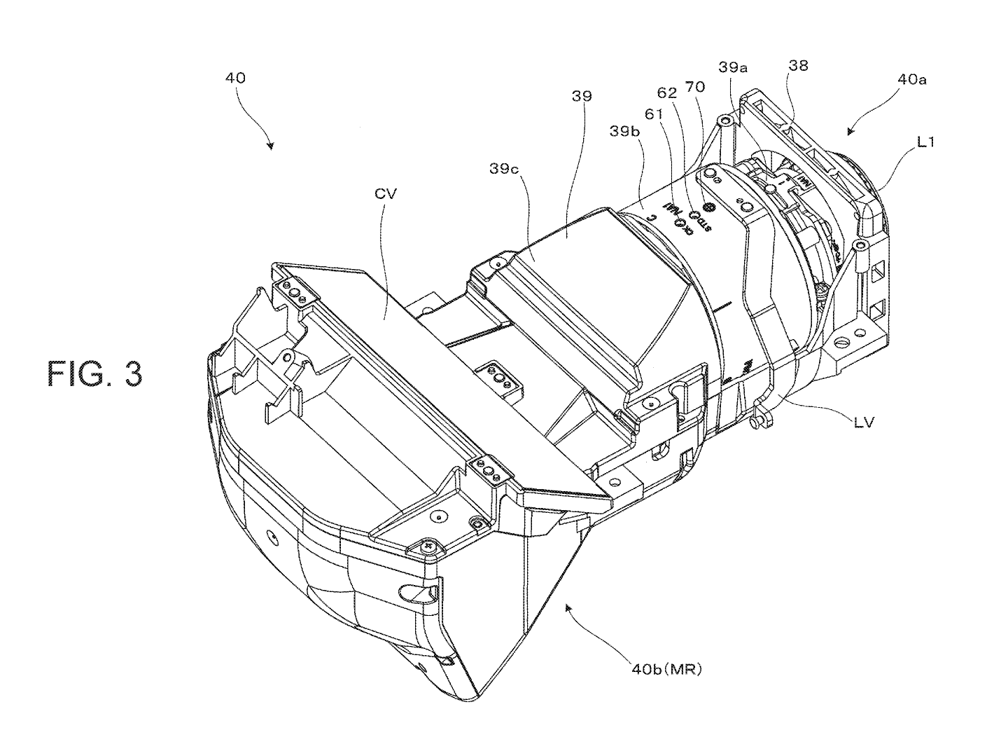

As shown in FIG. 4 or FIG. 5, the position-adjustment cam cylinder 39b includes cam mechanisms CA on an inner surface to correspond to the protrusion sections TP extending on the outer surface of the lens-barrel guide cylinder 39a. The cam mechanisms CA can be rotated with respect to the lens-barrel guide cylinder 39a by rotating the attached lever section LV. That is, in a state in which the position-adjustment cam cylinder 39b is assembled with the position-adjustment cam cylinder 39b shown in FIG. 2, FIG. 3, or the like, the position-adjustment cam cylinder 39b moves, with the cam mechanisms CA, the protrusion sections TP (i.e., a lens group housed on the inside of the lens-barrel guide cylinder 39a) along the optical axis direction according to a rotating motion (in a circumferential direction R1 shown in FIG. 5). Note that the structure formed by the cam mechanisms CA and the protrusion sections TP is simply referred to as cam as well.

Repeating the above description, in the lens barrel section 39, the lens-barrel guide cylinder 39a and the position-adjustment cam cylinder 39b cooperate to be capable of independently moving, in focus adjustment, along the optical axis, lenses configuring a movable lens group movable in the focus adjustment. Note that, concerning a method of moving the lens groups (i.e., the frame bodies) of the lens-barrel guide cylinder 39a, various forms are possible according to a method of performing the focus adjustment. For example, the lens groups that independently move using the cam mechanism CA of the position-adjustment cam cylinder 39b described above may move in association with one another. Concerning a fixed lens group that does not move in a state after the projection optical system 40 is manufactured as the product, position adjustment along the optical axis direction and posture adjustment concerning a direction other than the optical axis direction are possible during the manufacturing.

The mirror cylinder 39c houses the mirror MR (the second optical group 40b) and is assembled to the lens-barrel guide cylinder 39a and the position-adjustment cam cylinder 39b to perform positioning of the second optical group 40b with respect to the first optical group 40a and form a part of the exterior of the entire projection optical system 40. Note that, as shown in FIG. 6, the mirror cylinder 39c includes a mirror-posture adjusting mechanism Pb in which a space, a spring member, and the like for adjusting a posture of the mirror MR (the second optical group 40b) are provided.

In this embodiment, as shown in, for example, FIGS. 2 and 3, various mechanisms for restricting a rotating motion in the lens barrel section 39 in position adjustment of lenses are provided between the lens-barrel guide cylinder 39a and the position-adjustment cam cylinder 39b. Specifically, the lens barrel section 39 includes a rotation restricting section 61 that restricts a rotation range for confirming that a focus adjustment range is a proper range at a predetermined projection distance after the position adjustment of the lenses, a rotation fixing section 62 that maintains a relative positional relation between the lens-barrel guide cylinder 39a and the position-adjustment cam cylinder 39b while fixing the relative positional relation in a predetermined state (e.g., in a position substantially in the center of a movable range of the lens-barrel guide cylinder 39a and the position-adjustment cam cylinder 39b) in the position adjustment of the lenses, and a zoom adjusting mechanism 70 for restricting a rotation range of focus adjustment during a zoom motion (e.g., a motion for changing a projection size by changing a projection distance) after the position adjustment for focusing (in a state of the product). Among these sections, the rotation restricting section 61 and the rotation fixing section 62 are used for the position adjustment of the lenses, which is one process in a manufacturing process. On the other hand, the zoom adjusting mechanism 70 is used for focus adjustment involved in zooming during setting and during use of an apparatus after manufacturing completion. In an example shown in the figures, the rotation restricting section 61, the rotation fixing section 62, and the zoom adjusting mechanism 70 are disposed side by side along the optical axis direction in the lens barrel section 39. Further, a bar-like jig JG (e.g., a bar-like pin) explained below is used in common to the rotation restricting section 61 and the rotation fixing section 62 (the jig JG is used for both of the rotation restricting section 61 and the rotation fixing section 62). That is, the same jig JG is exchanged to be used for the rotation restricting section 61 and for the rotation fixing section 62.

As shown in FIG. 5 and the like, the rotation restricting section 61 is configured by a first restricting section 61a provided in the lens-barrel guide cylinder 39a and a second restricting section 61b provided in the position-adjustment cam cylinder 39b. The first restricting section 61a and the second restricting section 61b overlap each other in a state in which the lens-barrel guide cylinder 39a and the position-adjustment cam cylinder 39b are assembled shown in FIG. 2 and the like. The bar-like jig JG shown in FIG. 4 or FIG. 5 is inserted into an overlapping part and used to enable rotation restriction in the cam concerning the circumferential direction R1. More specifically explained, the first restricting section 61a is configured by a concave section or a hole section extending along the circumferential direction R1 on the outer surface of the lens-barrel guide cylinder 39a. As an example, the first restricting section 61a is a groove (a concave section) provided on the outer surface of the lens-barrel guide cylinder 39a. The first restricting section 61a has a certain degree of width P1 between both ends Ea and Eb concerning the circumferential direction R1. On the other hand, the second restricting section 61b is configured by a hole section including a hole (a through-hole) having a degree of size into which the bar-like jig JG can be just inserted. Consequently, the jig JG pierces through the second restricting section 61b of the position-adjustment cam cylinder 39b and reaches the first restricting section 61a of the lens-barrel guide cylinder 39a. The tip of the jig JG is movable in the width P1 between both the ends Ea and Eb of the first restricting section 61a. From another perspective, a range in which the rotation restricting section 61 configured as explained above restricts a rotation range in the cam is set to be a range between one end Ea and the other end Eb. If position adjustment is within this restriction range, the position adjustment is allowed as position adjustment for focusing during the manufacturing (a product requiring further adjustment is determined as a defective product having excessively large shift). A person who performs adjustment can recognize that the adjustment reaches a limit of a restrictable range by feeling that the jig JG hits one of the ends Ea and Eb.

The rotation fixing section 62 is configured by, as shown in FIG. 5 and the like, a first fixing section 62a provided in the lens-barrel guide cylinder 39a and a second fixing section 62b provided in the position-adjustment cam cylinder 39b. The first fixing section 62a and the second fixing section 62b overlap each other in the state in which the lens-barrel guide cylinder 39a and the position-adjustment cam cylinder 39b are assembled shown in FIG. 2 and the like. The bar-like jig JG is inserted into an overlapping part and used to enable rotation fixing in the cam between the lens-barrel guide cylinder 39a and the position-adjustment cam cylinder 39b concerning the circumferential direction R1. More specifically explained, the first fixing section 62a is configured by a concave section or a hole section having a degree of size into which the bar-like jig JG can be just inserted on the outer surface of the lens-barrel guide cylinder 39a. On the other hand, the second fixing section 62b is configured by a hole section including a hole (a through-hole) having the same degree of size as the first fixing section 62a. Consequently, in a state in which the jig JG is inserted into the rotation fixing section 62, the lens-barrel guide cylinder 39a and the position-adjustment cam cylinder 39b are always in an integrated state. In other words, the rotation fixing section 62 maintains a relative positional relation between the lens-barrel guide cylinder 39a and the position-adjustment cam cylinder 39b while fixing the positional relation. In the position adjustment of the lenses in the manufacturing process, the disposition of the lenses can be fixed and maintained in a predetermined state by inserting the jig JG into the rotation fixing section 62. It is assumed that, as a pre-stage of the position adjustment for focusing by the rotation restricting section 61, the first optical group 40a is maintained by the rotation fixing section 62 in a predetermined state in which the first optical group 40a is the substantial center of a rotation range in the focus adjustment.

Lastly, the zoom adjusting mechanism 70 is configured by, as shown in FIG. 5 and the like, a guide groove for zooming 70a provided in the lens-barrel guide cylinder 39a and a stopper 70b provided in the position-adjustment cam cylinder 39b. The guide groove for zooming 70a and the stopper 70b overlap each other in the state in which the lens-barrel guide cylinder 39a and the position-adjustment cam cylinder 39b are assembled shown in FIG. 2 and the like. The stopper 70b is movable in a width P2 between both ends Ta and Tb of the guide groove for zooming 70a.

Concerning a movement range in the guide groove for zooming 70a of the stopper 70b (i.e., the width P2 between the ends Ta and Tb) in the zoom adjusting mechanism 70, a certain degree of margin is provided to be equal to or larger than necessary performance (e.g., a function capable of performing focus adjustment in a projected image range of 60 to 100 inches) anticipating a manufacturing error in the projection optical system 40. If focus is on within the rotation range of restriction by the rotation restricting section 61 explained above (i.e., the width P1 between the ends Ea and Eb), the necessary performance (zoom function) is maintained. On the other hand, if focusing cannot be performed within the range, the projection optical system 40 is treated as an unadjustable defective product. That is, the rotation restricting section 61 restricts a rotation range for adjustment of a focus position within a range equal to or smaller than a margin of a rotation range for enabling the screen size to be changed.

In general, in a projection optical system that performs projection (short-distance projection) at a wide angle of view from a short distance (see, for example, FIG. 7), the distance among lenses configuring the projection optical system tends to be narrow because of a mechanical restriction. There is a limitation on movement of lenses. On the other hand, an aspherical lens and a mirror tend to be used as lenses configuring an optical system. The number of components tends to increase. Therefore, fluctuation in accuracy, that is, a manufacturing error easily occurs in manufacturing of the projection optical system. Therefore, for example, it is important to perform position adjustment of the lenses every time in order to adjust a focus in a manufacturing process. However, the adjustment cannot always be easily and accurately performed because of the mechanical restriction. Moreover, after the manufacturing, there is a demand that movement of the lenses to a certain degree be allowed for a zoom function. It is likely that a stricter demand is imposed concerning the position adjustment of the lenses.

On the other hand, in the projection optical system 40 in this embodiment, the rotation restricting section 61 has the configuration explained above. Therefore, by restricting rotation ranges of the cam in the lens-barrel guide cylinder 39a and the position-adjustment cam cylinder 39b, it is possible to easily and surely check in the manufacturing process that the performance (e.g., the zoom function) of the projection optical system 40 required for a product is maintained.

In the manufacturing process of the projection optical system 40 having the configuration explained above, an example of processes concerning a position adjusting process for focusing in which the rotation restricting section 61 and the like are used is explained below.

First, the projection optical system 40 is assembled in a state of standard design in which the jig JG is inserted into the rotation fixing section 62 side. In this state, for example, a provisional liquid crystal panel (not shown in the figures) for position adjustment of the lenses is attached to the attachment section 38 side and projection at a standard distance is performed to form an image (74 inches) in a standard state. While this projection state is confirmed, first, posture adjustment of the sections of the optical system is performed. That is, various kinds of posture adjustment such as adjustment of a back focus in the lens-barrel guide cylinder 39a are performed. At this point, for example, in the lens-barrel guide cylinder 39a, a posture of the lens L15 closest to the mirror MR in the first optical group 40a may be adjusted by the lens-posture adjusting mechanism Pa. Specifically, the lens-posture adjusting mechanism Pa includes a first hole section HLa (see FIG. 5) into which a jig can be inserted concerning the horizontal direction (an x direction) and a second hole section HLb (see FIG. 5) into which a jig can be inserted concerning the vertical direction (a y direction) and includes elastic members (not shown in the figures) such as spring members provided on the opposite side to correspond to the respective hole sections. The lens-posture adjusting mechanism Pa is capable of performing adjustment of a posture concerning an xy plane perpendicular to the optical axis direction.

After the posture adjustment in the lens-barrel guide cylinder 39a, position adjustment for focusing in which the rotation restricting section 61 is used is performed. Specifically, first, the jig JG inserted into the rotation fixing section 62 side is reinserted into the rotation restricting section 61 side. Consequently, as explained above, the position adjustment (fine adjustment) for focusing by rotation of the cam in the lens-barrel guide cylinder 39a and the position-adjustment cam cylinder 39b is performed within the range of restriction by the rotation restricting section 61. In this case, the position-adjustment cam cylinder 39b functions as a focus-position adjustment cam cylinder that adjusts a focus position under the restriction by the rotation restricting section 61. In design theory, a state of standard design is the best. The fine adjustment should be unnecessary after the position adjustment of the lenses. However, as explained above, in particular, in the case of an optical system of near profection, an actual lens shape, an assembly state, and the like often deviate from design theoretical values because of a manufacturing error. Therefore, the adjustment (the fine adjustment) by the position-adjustment cam cylinder 39b functioning as the focus-position adjustment cam cylinder is necessary. If adjustment to optimum positions for focusing is possible within the rotation range of the restriction by the rotation restricting section 61 according to the adjustment, markers are applied to the lens-barrel guide cylinder 39a and the position-adjustment cam cylinder 39b when the adjustment to the position is performed. Consequently, it is possible to prevent a positional relation of a state adjusted above from being forgot in the subsequent various manufacturing processes. For example, after the position adjustment for focusing and various processes of inspection are performed, when the projection optical system 40 is attached to the liquid crystal panel 18G and the like (see FIG. 1) configuring the projector 2 while the position adjustment is performed, it is conceivable to use the markers. Note that, when it is determined that the position adjustment for focusing cannot be performed within the rotation range of restriction by the rotation restricting section 61, the projection optical system 40 is treated as unadjustable defective products.

Besides the above, for example, as a process before the end, in the mirror cylinder 39c, a posture of the mirror MR (the second optical group 40b) may be adjusted by the mirror-posture adjusting mechanism Pb. Specifically, it is possible to perform trapezoidal correction and the like by changing the posture of the mirror MR with a space, a spring member, and the like in the mirror cylinder 39c provided as the mirror-posture adjusting mechanism Pb.

As explained above, in the projection optical system 40 according to this embodiment, the rotation restricting section 61 capable of restricting the rotation range of the cam in the focus position adjustment (the position adjustment among the lenses) during the manufacturing process according to the rotating motion of the cam in the lens-barrel guide cylinder 39a and the position-adjustment cam cylinder 39b. Consequently, in particular, in application of a projector that performs short-distance projection, in particular, even in position adjustment of lenses in which restriction tends to be strict such as focus position adjustment in a manufacturing process, it is possible to easily and accurately perform the position adjustment.

Note that, in the above explanation, in the manufacturing process, for example, during adjustment, photosetting resin is applied in advance to an optical system (together with lenses and mirrors), which is fixed after the adjustment. After the adjustment (after decision of a fixing position), the optical system is positioned and fixed by irradiating with UV light.

A configuration example of the optical system of the projection optical system 40 in the embodiment is specifically explained below with reference to FIG. 6 to FIG. 8.

The projection optical system 40 includes, in order from a reduction side, a 1-1-th lens group 41 and a 1-2-th lens group 42 configuring the first optical group 40a and the second optical group 40b. Further, as shown in FIG. 8, the 1-1-th lens group 41 includes a lens group E1 (lenses L1 to L7) further on the reduction side than an aperture top ST and a lens group E2 (lenses L8 and L9) further on an expansion side than the aperture stop ST. The lens L6 is a lens having an aspherical shape made of glass. The other lenses are lenses having a spherical shape made of glass. Note that the lens L2, which is a positive lens, and the lens L3, which is a negative lens, are cemented lenses. The lens L4 and the lens L5 are cemented lenses.

The 1-2-th lens group 42 includes, in order from the reduction side, three lens groups, that is, a positive first movable lens group F1 including three lenses (lenses L10 to L12), a second movable lens group F2 including two lenses (lenses L13 and L14), and a third movable lens group F3 including one negative lens (the lens L15). The lens groups F1 to F3 are respectively housed in a plurality of frame bodies configuring the lens barrel section 39. When focusing is performed, the lens groups F1 to F3 are moved in the optical axis direction (a direction A1 along the optical axis OA) independently from one another for each of the frame bodies by the lever section LV. Note that the lens L15 is a resin lens (an aspherical lens), to both surfaces of which having negative power aspherical surfaces are applied. The lens L15 has a shape obtained by cutting a portion where a ray does not pass in a circular aspherical lens. The lenses L13 and L14 configuring the second movable lens group F2 are cemented glass lenses. The lenses L13 and L14 have a shape obtained by cutting an upper part of a lens such that the lenses L13 and L14 do not eclipse light emitted from the second optical group 40b configured by mirror lenses to the screen. That is, the lenses L13 to L15 have a shape obtained by cutting out a part of an upper side (a side on which image light is projected) from an axially symmetrical circular state concerning the optical axis OA.

As explained above, the second optical group 40b is configured by the one mirror MR having the concave aspherical shape. The mirror MR reflects image light emitted from the first optical group 40a toward the screen.

The present invention is not limited to the embodiment and the examples explained above. The present invention can be carried out in various forms in a range not departing from the spirit of the present invention.

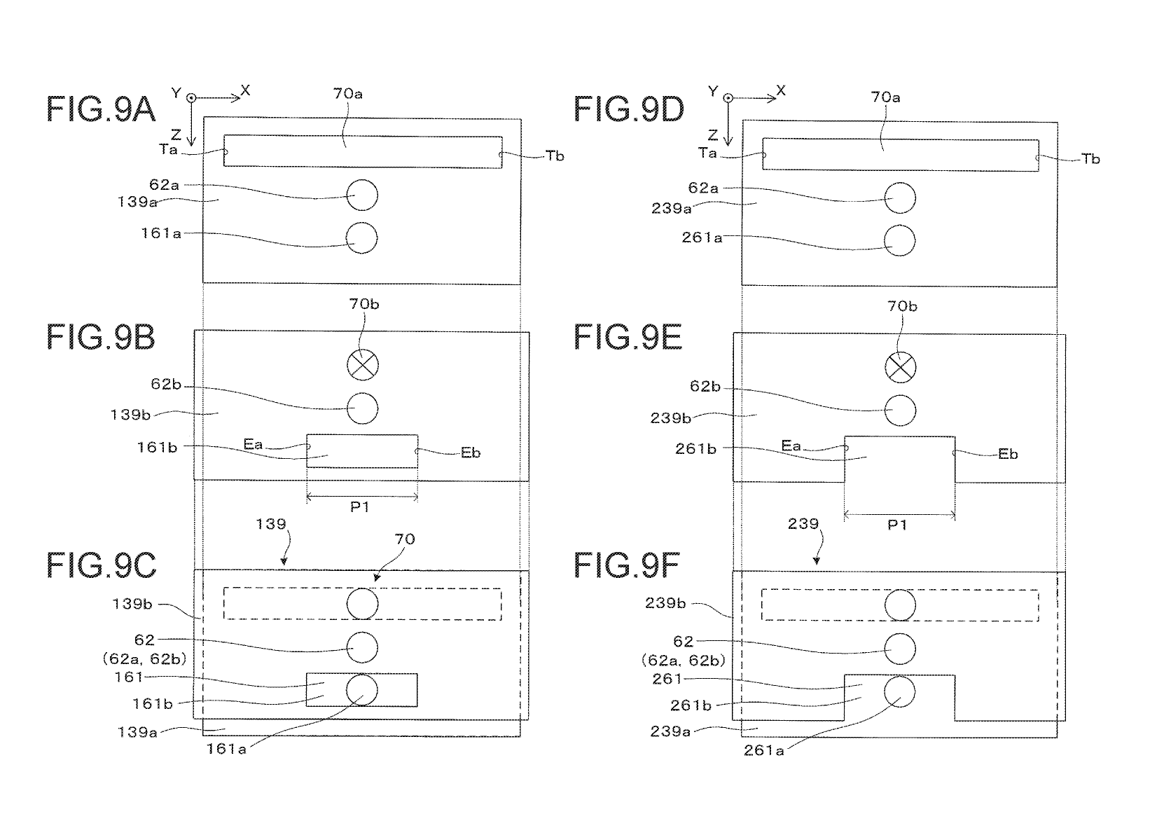

In the above explanation, concerning the rotation restricting section 61, as an example, the first restricting section 61a provided in the lens-barrel guide cylinder 39a includes the concave section having the certain degree of width. On the other hand, the second restricting section 61b includes the hole (the through-hole) having the degree of size into which the jig can be inserted. However, not only this, but various modified forms are applicable. Specifically, for example, as indicated by a modified example in FIGS. 9(A) to 9(C), in a lens barrel section 139, a first restricting section 161a provided in a lens-barrel guide cylinder 139a may include a concave section having a degree of size into which the jig can be inserted. A second restricting section 161b provided in a position-adjustment cam cylinder 139b may include a hole (a through-hole) having a certain degree of the width P1 that decides an adjustable range. For example, as shown as another modified example in FIGS. 9(D) to 9(F), in a lens barrel section 239, a first restricting section 261a provided in a lens-barrel guide cylinder 239a may be configured by a concave section having a degree of size into which the jig can be inserted. A second restricting section 261b provided in a position-adjustment cam cylinder 239b may be configured by a cutout section having a certain degree of the width P1 that decides an adjustable range.

In the above explanation, the projection optical system 40 is configured by the fifteen lenses and the one mirror having the concave aspherical shape. However, this is an example, the number of lenses and the number of mirrors are not limited to these numbers and can be set to various numbers.

For example, in the examples explained above, one or more lenses substantially not having power can be added before and behind or among the lenses configuring the lens groups.

In the above explanation, the projection optical system 40 includes the actuator AC. The lens driving section 83 is configured to move the lever section LV via the actuator AC to perform focus adjustment. However, the lever section LV may be manually moved.

In the above explanation, the lens driving section 83 is configured to move the entire projection optical system 40 in the up-down direction perpendicular to the optical axis OA. However, the projection optical system 40 maybe manually moved or a moving mechanism may be not provided.

Image light formed by various light modulating elements such as a digital micro-mirror device may be enlarged and projected by the projection optical system 40.

### REFERENCE SIGNS LIST

A1 direction

AC actuator

CA cam mechanism

CV cover member

E1 first lens group

E2 second lens group

Ea, Eb end

F1 to F3 movable lens group

HLa, HLb hole section

JG jig

L1 to L15 lens

LV lever section

MR mirror

OA optical axis

P1, P2 width

Pa lens-posture adjusting mechanism

Pb mirror-posture adjusting mechanism

R1 circumferential direction

TP protrusion section

Ta, Tb end

2 projector

10 light source

11, 12 integrator lens

13 polarization conversion element

14 superimposition lens

15 dichroic mirror

16 reflection mirror

17G, 17R, 17B field lens

18G, 18R, 18B liquid crystal panel (light modulating element)

19 cross dichroic prism

21 dichroic mirror

22 relay lens

23 reflection mirror

38 attachment section

39 lens barrel section

39a lens-barrel guide cylinder

39b position-adjustment cam cylinder (focus-position adjustment cam cylinder)

39c mirror cylinder

40 projection optical system

40a first optical group

40b second optical group

41 lens group

42 lens group

50 optical system portion

61 rotation restricting section

61a first restricting section (concave section or hole section)

61b second restricting section (hole section)

62 rotation fixing section

62a first fixing section

62b second fixing section

70 zoom adjusting mechanism

70a guide groove for zooming

70b stopper

80 circuit device

81 image processing section

82 display driving section

83 lens driving section

88 main control section

139 lens barrel section

139a lens-barrel guide cylinder

139b position-adjustment cam cylinder

161a first restricting section

161b second restricting section

239 lens barrel section

239a lens-barrel guide cylinder

239b position-adjustment cam cylinder

261a first restricting section

261b second restricting section (cutout section)

1. A projection optical system comprising:
a lens-barrel guide cylinder that houses a lens group;
a position-adjustment cam cylinder for position adjustment of the lens group housed in the lens-barrel guide cylinder; and
a rotation restricting section capable of restricting rotation ranges of a cam in the lens-barrel guide cylinder and the position-adjustment cam cylinder.

2. The projection optical system according to claim 1, further comprising a rotation fixing section capable of fixing a relative positional relation by the cam between the lens-barrel guide cylinder and the position-adjustment cam cylinder.

3. The projection optical system according to claim 2, wherein the rotation restricting section and the rotation fixing section are capable of respectively performing rotation restriction and rotation fixing by using a jig.

4. The projection optical system according to claim 2, wherein the rotation restricting section and the rotation fixing section are disposed side by side and respectively capable of performing rotation restriction and rotation fixing by exchanging a same jig.

5. The projection optical system according to claim 1, wherein
the rotation restricting section includes:
a first restricting section that forms a concave section or a hole section provided in the lens-barrel guide cylinder; and
a second restricting section that forms a hole section or a cutout section provided in the position-adjustment cam cylinder, and
one of the first restricting section and the second restricting section extends along a circumferential direction of the lens-barrel guide cylinder.

6. The projection optical system according to claim 1, wherein the position-adjustment cam cylinder adjusts a focus position under restriction by the rotation restricting section.

7. The projection optical system according to claim 6, wherein the rotation restricting section restricts a rotation range for adjustment of a focus position within a range equal to or smaller than a margin of a rotation range of the lens group for enabling focus adjustment in a screen size in a predetermined range.

8. The projection optical system according to claim 1, further comprising a lens-posture adjusting mechanism that adjusts a posture of at least one lens among a plurality of lenses configuring the lens group.

9. The projection optical system according to claim 1, further comprising:
a curved surface mirror disposed at an optical path post stage of the lens group; and
a mirror-posture adjusting mechanism that adjusts a posture of the curved surface mirror.

10. A projector comprising:
a light modulating element that modulates light emitted from a light source and forms image light; and
the projection optical system according to claim 1 that projects the image light emitted from the light modulating element.

11. A projector comprising:
a light modulating element that modulates light emitted from a light source and forms image light; and
the projection optical system according to claim 2 that projects the image light emitted from the light modulating element.

12. A projector comprising:
a light modulating element that modulates light emitted from a light source and forms image light; and
the projection optical system according to claim 3 that projects the image light emitted from the light modulating element.

13. A projector comprising:
a light modulating element that modulates light emitted from a light source and forms image light; and
the projection optical system according to claim 4 that projects the image light emitted from the light modulating element.

14. A projector comprising:
a light modulating element that modulates light emitted from a light source and forms image light; and
the projection optical system according to claim 5 that projects the image light emitted from the light modulating element.

15. A projector comprising:
a light modulating element that modulates light emitted from a light source and forms image light; and
the projection optical system according to claim 6 that projects the image light emitted from the light modulating element.

16. A projector comprising:
a light modulating element that modulates light emitted from a light source and forms image light; and
the projection optical system according to claim 7 that projects the image light emitted from the light modulating element.

17. A projector comprising:
a light modulating element that modulates light emitted from a light source and forms image light; and
the projection optical system according to claim 8 that projects the image light emitted from the light modulating element.

18. A projector comprising:
a light modulating element that modulates light emitted from a light source and forms image light; and
the projection optical system according to claim 9 that projects the image light emitted from the light modulating element.
